(19) United States
(12) Patent Application Publication
(10) Pub. No.: US 2020/0049519 A1
(43) Pub. Date: Feb. 13, 2020

(54) AUTONOMOUS VALET SERVICE APPARATUS AND METHOD

(71) Applicants: HYUNDAI MOTOR COMPANY, Seoul (KR); KIA MOTORS CORPORATION, Seoul (KR)

(72) Inventor: Seo Hyun YOON, Anyang-si (KR)

(73) Assignees: HYUNDAI MOTOR COMPANY, Seoul (KR); KIA MOTORS CORPORATION, Seoul (KR)

(21) Appl. No.: 16/170,339

(22) Filed: Oct. 25, 2018

(30) Foreign Application Priority Data
Aug. 9, 2018 (KR) 10-2018-0093197

(51) Int. Cl. G01C 21/34; G05D 1/00; G05D 1/02

(52) U.S. Cl. CPC G01C 21/3438; G05D 1/0276; G05D 1/0088

(57) ABSTRACT

The present disclosure relates to an autonomous valet service apparatus for autonomously driving by setting a waiting track until a driver returns to the vehicle in a state where a parking space is insufficient, and a method thereof. The autonomous valet service apparatus sets a waiting track for the autonomous valet service after starting an autonomous valet service of a vehicle, and stands by while performing autonomous driving of the vehicle in the set waiting track.

### CROSS-REFERENCE TO RELATED APPLICATION

This application claims priority to and the benefit of Korean Patent Application No. 10-2018-0093197, filed ice on Aug. 9, 2018, the entire contents of which are incorporated herein by reference.

### FIELD

The present disclosure relates to an autonomous valet service apparatus for autonomous driving, and a method thereof.

### BACKGROUND

The statements in this section merely provide background information related to the present disclosure and may not constitute prior art.

Because the parking lot is narrow compared with the number of vehicles visiting department stores, sightseeing spots, shopping malls, government offices and the like, it takes a lot of time to enter a parking lot and to find a parking space. Also, a driver may have difficulty in parking due to the many vehicles.

Furthermore, in specific tourists or government offices, parking is not available or parking expenses are charged excessively, and thus the driver feels inconvenient.

### SUMMARY

The present disclosure addresses the above-mentioned problems occurring in the prior art while advantages achieved by the prior art are maintained intact.

An aspect of the present disclosure provides an autonomous valet service apparatus for autonomously driving by setting a waiting track until a driver returns to the vehicle in a state where a parking space is insufficient, and a method thereof.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an autonomous valet service method includes: starting, by a processor, an autonomous valet service of a vehicle; setting, by the processor, a waiting track for the autonomous valet service; and performing, by the processor, autonomous driving of the vehicle in the waiting track.

The setting the waiting track includes: setting a unit time, obtaining a current location of the vehicle, generating at least one circulation route in each of which the current location of the vehicle is a start point or a destination, and selecting one circulation route of the at least one circulation route based on the unit time.

The setting the waiting track includes obtaining information of the waiting track from map data based on a current location of the vehicle.

The setting the waiting track includes downloading information of the waiting track through scanning a Quick Response (QR) code or a barcode.

The performing the autonomous driving of the vehicle includes measuring a current location of the vehicle in real time, and transmitting the current location to a user terminal.

The performing the autonomous driving of the vehicle includes determining whether a call is received from the user terminal.

After the performing the autonomous driving of the vehicle, the method further includes: obtaining a vehicle location in the waiting track based on the call from the user terminal, calculating a movement time from the vehicle location to a pickup location, transmitting an expected time to arrive at the pickup location based on the calculated movement time, and moving to the pickup location.

The pickup location is implemented with a location designated by the user terminal.

The pickup location is implemented with the current location of the user terminal.

The pickup location is implemented with an exit location of the waiting track.

According to an aspect of the present disclosure, an autonomous valet service apparatus includes: a user input device to activate an autonomous valet service, a vehicle controller controlling autonomous driving of a vehicle, and a processor. In particular, the processor is configured to start the autonomous valet service based on an input from the user input device, to set a waiting track for the autonomous valet service, and to control the vehicle controller to perform the autonomous driving of the vehicle in the waiting track.

The autonomous valet service apparatus further includes a location measurement device measuring a vehicle location.

The processor is configured to generates at least one circulation route, in each of which the vehicle location is a start point or a destination and to select one circulation route of the at least one circulation route as the waiting track based on a preset unit time.

In one form, the at least one circulation route comprises a plurality of circulation routes, and the processor is configured to determine a circulation route of the plurality of circulation routes as the waiting track when a time for the vehicle to move along the circulation route is the most similar to the preset unit time.

The autonomous valet service apparatus further includes a memory storing map data. The processor is configured to obtain information of the waiting track from the map data.

The processor is configured to obtain information of the waiting track through scanning a Quick Response (QR) code or a barcode.

The autonomous valet service apparatus further includes a communication device performing wireless communication with a user terminal. The processor is configured to measure in real time a current location of the vehicle under the autonomous driving in the waiting track and to transmit the current location to the user terminal.

The processor is configured to calculate a movement time from the current location of the vehicle to a pickup location based on a call from the user terminal and to transmit an expected time to arrive at the pickup location based on the calculated movement time, to the user terminal.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram illustrating an autonomous valet service system;

FIG. 2 is a block diagram of an autonomous valet service apparatus;

FIG. 3 is a diagram for describing a procedure of setting a waiting track;

FIG. 4 is a flowchart illustrating an autonomous valet service method; and

FIG. 5 is a flowchart illustrating a procedure of setting a waiting track illustrated in FIG. 4.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

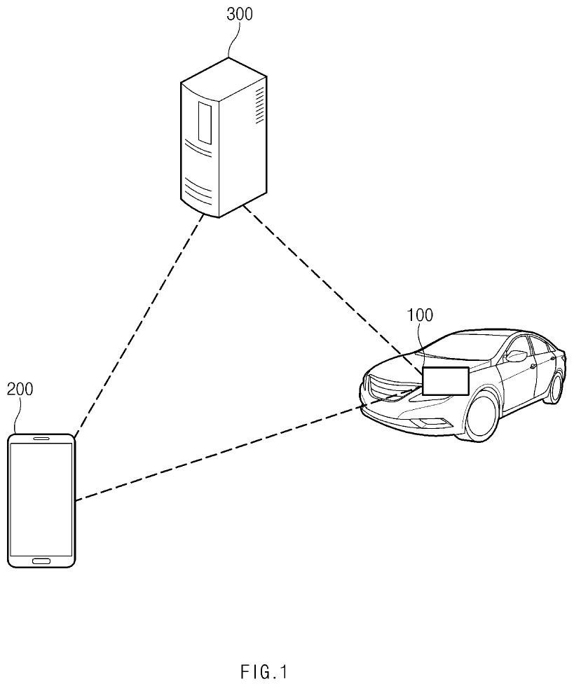

FIG. 1 is a diagram illustrating an autonomous valet service system in one form of the present disclosure.

As illustrated in FIG. 1, the autonomous valet service system includes an autonomous valet service apparatus 100, a user terminal 200, and a control server 300.

The autonomous valet service apparatus 100 may be a device that is mounted in a vehicle and supports an autonomous valet service. The autonomous valet service moves a vehicle to a specified place (location) to pick up a user when there is a call from the user while the vehicle stands by in a state where the vehicle performs autonomous driving on a predetermined driving path (route).

The user terminal 200 performs data communication with the autonomous valet service apparatus 100 wirelessly. The user terminal 200 may exchange data with the autonomous valet service apparatus 100 through an app installed in a terminal. The user terminal 200 may transmit a vehicle call signal to the autonomous valet service apparatus 100 and may receive vehicle location information from the autonomous valet service apparatus 100. Although not illustrated in FIG. 1, such the user terminal 200 includes a communication module, a user input module, an output module, a Global Positioning System (GPS) receiver, a processor, and a memory.

The user terminal 200 may be implemented with a smartphone, a tablet, a Personal Digital Assistant (PDA), and/or a notebook computer.

The control server 300 exchanges data with the autonomous valet service apparatus 100 and the user terminal 200 over wireless communication. The control server 300 manages information about a waiting track for an autonomous valet service and a state associated with the waiting track. The control server 300 manages track information such as the shape of a waiting track, a driving direction, an entrance location, an exit location, and the like and state information such as the degree of congestion in the waiting track, whether a parking lot is full, and the like.

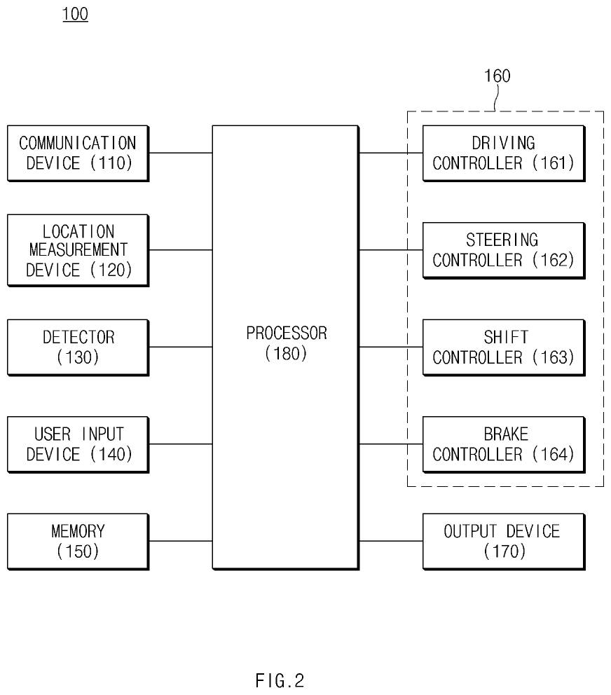

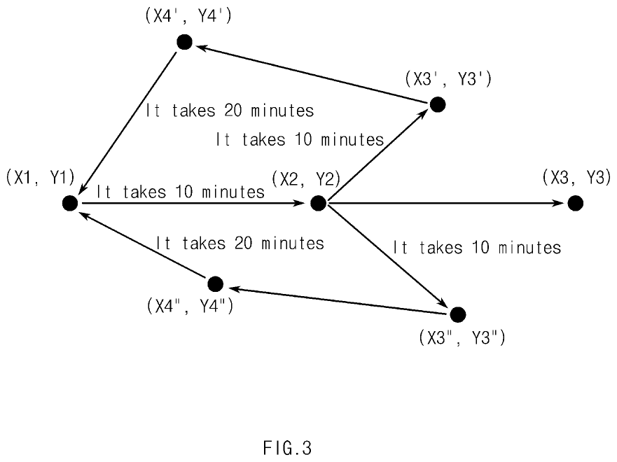

FIG. 2 illustrates a block diagram of an autonomous valet service apparatus, in one form of the present disclosure. FIG. 3 is a diagram for describing a procedure of setting a waiting track associated with the present disclosure.

As illustrated in FIG. 2, the autonomous valet service apparatus 100 includes a communication device 110, a location measurement device 120, a detector 130, a user input device 140, a memory 150, a vehicle controller 160, an output device 170, and a processor 180.

The communication device 110 wirelessly communicates with the user terminal 200 and/or the control server 300. A wireless Internet technology such as Wireless LAN (WLAN) (Wi-Fi), Wireless broadband (Wibro), World Interoperability for Microwave Access (Wimax), and the like, a short range communication technology such as Bluetooth, Near Field Communication (NFC), Radio Frequency Identification (RFID), infrared Data Association (IrDA), Ultra-Wideband (UWB), ZigBee, and the like, and/or a mobile communication technology such as Code Division Multiple Access (CDMA), Global System for Mobile communication (GSM), Long Term Evolution (LTE), LTE-Advanced, and the like may be used as a wireless communication technology.

The location measurement device 120 measures the current location of a vehicle. The location measurement device 120 may be implemented with a Global Positioning System (GPS) module. The GPS receiver 120 calculates the current location of the vehicle by using signals transmitted from three or more GPS satellites. The GPS receiver 120 calculates the distance between a satellite and the GPS receiver 120 using the time difference between the time of transmitting a signal from the satellite and the time of receiving the signal from the GPS receiver 120. The GPS receiver 120 calculates the current location of the vehicle by using information about the calculated distance between a satellite and the GPS receiver 120 and information about a location of the satellite included in the transmitted signal. At this time, the GPS receiver 120 calculates the current location using a triangulation method.

The detector 130 obtains vehicle peripheral information through one or more sensors mounted in the vehicle. The detector 130 detects vehicle peripheral information such as an image at a periphery of the vehicle, the distance between the vehicle and a rear vehicle, the relative speed of the rear vehicle, a forward vehicle, an obstacle, and/or a traffic light, through an image sensor, Radio Detecting And Ranging (radar), Light Detection And Ranging (LiDAR), and/or an ultrasonic sensor.

The image sensor obtains an image (e.g., a front view image, a rear view image, and a side view image) at a periphery of the vehicle. The image sensor may be implemented with at least one or more image sensors among image sensors such as a charge coupled device (CCD) image sensor image sensor, a complementary metal oxide semi-conductor (CMOS) image sensor, a charge priming device (CPD) image sensor, a charge injection device (CID) image sensor, and the like.

The radar measures a distance between the vehicle and a surrounding object. The radar may emit electromagnetic waves to the surrounding object, may receive electromagnetic waves reflected from the surrounding object, and may verify the distance from the surrounding object, the direction of the surrounding object, and the altitude of the surrounding object.

The LiDAR measures a distance between a vehicle and a surrounding object. The LiDAR may calculate the spatial location coordinates of the reflection point by scanning a laser pulse to measure the arrival time of the laser pulse reflected from the surrounding object, and thus may verify the distance from the surrounding object and the shape of the surrounding object.

The ultrasonic sensor generates ultrasonic waves to detect surrounding objects and measures the distance between the vehicle and a surrounding object.

The detector 130 obtains vehicle information from one or more sensors and/or electric control units (ECUs), which are mounted in the vehicle. The detector 130 may detect the speed, acceleration, yaw rate and/or steering angle of a vehicle through a steering angle sensor, a speed sensor, a yaw rate sensor and/or an acceleration sensor. The detector 130 obtains vehicle information from the ECUs such as an airbag system, a vehicle door system, an electronic stability control (ESC), a traction control system (TCS), an antilock brake system (ABS), and the like, via a vehicle network. The vehicle network is implemented with Controller Area Network (CAN), Media Oriented Systems Transport (MOST) network, Local Interconnect Network (LIN), X-by-Wire (Flexray), or the like.

The user input device 140 may generate data according to a user's manipulation. For example, the user input device 140 generates data for turning on or off the function of the autonomous valet service in response to a user input. The user input device 140 may be implemented with a keyboard, a keypad, a button, a switch, a touch pad, and/or a touch screen.

The memory 150 may store software programmed for the processor 180 to perform the predetermined operation. The memory 150 may store map data, a navigation program, an algorithm for generating a waiting track, and the like.

The memory 150 may be implemented with at least one or more storage media (recording media) among a flash memory, a hard disk, a Secure Digital (SD) card, a Random Access Memory (RAM), a Read Only Memory (ROM), an Electrically Erasable and Programmable ROM (EEPROM), an Erasable and Programmable ROM (EPROM), a register, a removable disc, web storage, and the like.

The vehicle controller 160 controls the autonomous driving of the vehicle under control of the processor 180. The vehicle controller 160 includes a driving controller 161, a steering controller 162, a shift controller 163, and a brake controller 164.

The driving controller 161 controls the acceleration of the vehicle 200, as an actuator that controls engine of the vehicle. The driving controller 161 may be implemented with an Engine Management System (EMS). The driving controller 161 controls the driving torque of an engine depending on accelerator pedal location information output from an accelerator pedal location sensor. The driving controller 161 controls the output of the engine to follow the driving speed of the vehicle requested by the processor 180 during autonomous driving.

The steering controller 162 may be implemented with a Motor Drive Power Steering (MDPS), as an actuator that controls the steering of the vehicle. The steering controller 162 controls the steering angle of the vehicle under control of the processor 180.

The shift controller 163 may be implemented with a Shift-By-Wire (SBW), as an actuator for controlling the transmission (shift) of the vehicle. The shift controller 163 controls the transmission of the vehicle depending on a gear location and a gear state range.

The brake controller 164 may be implemented with an Electronic Stability Control (ESC), as an actuator that controls the deceleration of the vehicle. The brake controller 164 controls the brake pressure for the purpose of following the target speed requested by the processor 180 during autonomous driving. That is, the brake controller 164 controls the deceleration of the vehicle.

The output device 170 may output information generated depending on the operation of the processor 180 and may include a display, a sound output module, a haptic module, and the like.

The display may include one or more of a liquid crystal display (LCD), a thin film transistor-liquid crystal display (TFT LCD), an organic light-emitting diode (OLED) display, a flexible display, a 3D display, a transparent display, head-up display (HUD), a touch screen, and a cluster.

The sound output module may output the audio data stored in the memory 150. The sound output module may include a receiver, a speaker, and/or a buzzer. The haptic module outputs a signal of a type that the user can perceive with a tactile sense. For example, the haptic module may be implemented with a vibrator to control vibration intensity, a vibration pattern, and the like.

The processor 180 controls the overall operation of the autonomous valet service apparatus 100. The processor 180 may include at least one of an Application Specific Integrated Circuit (ASIC), a Digital Signal Processor (DSP), a Programmable Logic Devices (PLD), Field Programmable Gate Arrays (FPGAs), a Central Processing Unit (CPU), micro-controllers, and microprocessors.

The processor 180 enters an autonomous valet service mode in response to the user input that is input through the user input device 140. In other words, the processor 180 enters the autonomous valet service mode and then starts the autonomous valet service, when an autonomous valet service on is entered by a user. The processor 180 verifies a vehicle location through the location measurement device 120, when entering the autonomous valet service mode.

The processor 180 sets a waiting track (standby route) at the start of the autonomous valet service. Herein, the waiting track refers to the route on which the vehicle is driving while standing by.

The processor 180 generates at least one or more circulation routes in which the verified vehicle location is a start point (reference) and a destination. In other words, the processor 180 generates the circulation route in which the vehicle starts the current location of the vehicle and then returns to the current location. At this time, the processor 180 generates the circulation route by using map data stored in the memory 150.

The processor 180 calculates the time desired to drive along the respective generated circulation route. In other words, the processor 180 calculates the time to move from the start point to the destination of the respective generated circulation route. At this time, the processor 180 calculates the desired time in consideration of information about traffic conditions provided from the control server 300.

The processor 180 sets the circulation route, the calculated time of which is the most similar to the set unit time (e.g., 30 minutes) to the waiting track. The processor 180 determines the circulation route that returns to the start point for each set unit time, as a waiting track.

For example, referring to FIG. 3, the processor 180 generates at least one or more circulation routes in which the vehicle starts at a current location (X1, Y1) and then returns to the current location (X1, Y1), as follows, when the vehicle is located at the current location (X1, Y1) and the unit time is 40 minutes.
1) The first circulation route: (X1, Y1)-(X2, Y2)-(X3, Y3)-(X2, Y2)-(X1, Y1)
2) The second circulation route: (X1, Y1)-(X2, Y2)-(X3′, Y3′)-(X4′, Y4′)-(X1, Y1)
3) The third circulation route: (X1, Y1)-(X2, Y2)-(X3″, Y3″)-(X4″, Y4″)-(X1, Y1)

The processor 180 determines that a circulation route, along which a time desired to move is the most similar to the unit time of 40 minutes, from among the generated at least one or more circulation routes is a final circulation route (waiting track). As illustrated in the first circulation route, the processor 180 avoids a circulation route through U-turn, when determining the final circulation route.

The processor 180 selects one circulation route among the second circulation route and the third circulation route, in each of which the vehicle starts at the current location (X1, Y1) and then returns to the current location (X1, Y1) after 40 minutes, as the waiting track. At this time, the processor 180 determines the final circulation route by prioritizing the route with the shortest movement distance among the second circulation route and the third circulation route.

In the meantime, the processor 180 obtains the waiting track from the map data based on the verified vehicle location and then and sets the waiting track. The map data may include the predetermined waiting track information.

The processor 180 downloads the waiting track information through scanning a barcode or a Quick Response (QR) code by using an image sensor or a scanner to set the waiting track information. The waiting track information includes information such as information about track coordinates, track entrance coordinates, track exit coordinates, and a driving direction.

The processor 180 controls the vehicle controller 160 such that the vehicle drives autonomously along the waiting track when the setting of the waiting track is completed. The processor 180 controls the autonomous driving of the vehicle, based on the vehicle peripheral information and the vehicle state information detected through the detector 130. The processor 180 stands by while performing the autonomous driving of the vehicle along the waiting track. The processor 180 measures a vehicle location through the location measurement device 120 in real time to transmit the measured vehicle location to the user terminal 200. Accordingly, a user may verify the vehicle location through the user terminal 200 in real time. The user terminal 200 calculates a time required for the vehicle to move along the circulation route (the waiting track) from the current location (a vehicle location) to a user's location and then displays the required time.

The processor 180 may transmit the vehicle location measured through the location measurement device 120, to the control server 300. The control server 300 verifies vehicle coordinates in the waiting track, by using the vehicle location. The control server 300 transmits the verified vehicle coordinates to the vehicle.

The processor 180 may determine whether there is a user call, through the communication device 110 when the vehicle autonomously drives on the waiting track. The processor 180 receives a call command (a call signal) transmitted from the user terminal 200, through the communication device 110.

The processor 180 verifies vehicle location in the waiting track and information about the waiting track, through the control server 300 when receiving the user call. The processor 180 calculates the movement time to a pickup location, based on the verified vehicle location. The processor 180 calculates an expected time to arrive at the pickup location, based on the calculated movement time to transmit the expected time to the user terminal 200. The processor 180 controls the vehicle controller 160 to move the vehicle to the pickup location. Herein, the pickup location may be set to one of the user's current location, a location designated by the user, the predetermined location, and the exit location of the waiting track.

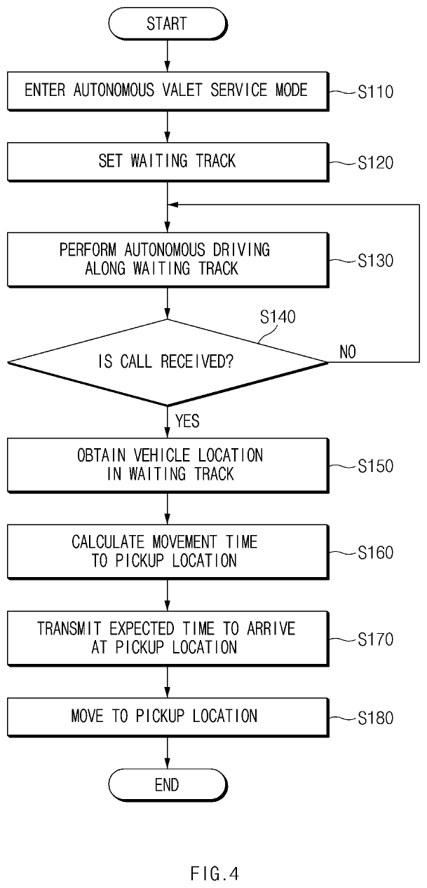

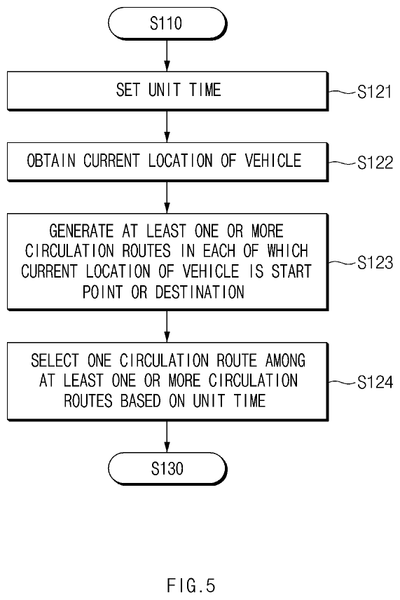

FIG. 4 is a flowchart illustrating an autonomous valet service method, according to an exemplary form of the present disclosure. FIG. 5 is a flowchart illustrating a procedure of setting a waiting track illustrated in FIG. 4.

Referring to FIG. 4, in operation S110, the processor 180 of the autonomous valet service apparatus 100 enters an autonomous valet service mode. The processor 180 enters the autonomous valet service mode to start an autonomous valet service, when a command of autonomous valet service on is input from the user input device 140.

After entering the autonomous valet service mode, in operation S120, the processor 180 sets a waiting track.

In more detail, referring to FIG. 5, in operation S121, the processor 180 sets a unit time. The unit time may be set by default in advance or may be set arbitrarily by a user.

In operation S122, the processor 180 obtains the current location of a vehicle through the location measurement device 120. In operation S123, the processor 180 generates at least one or more circulation routes in each of which the current location of the vehicle is a start point or a destination. At this time, the processor 180 generates the circulation route by using map data stored in the memory 150.

In operation S124, the processor 180 selects one circulation route among at least one or more circulation routes as the waiting track based on the unit time. The processor 180 calculates a time desired to move along the generated respective circulation routes and determines that a circulation route, along which a time desired to move is the most similar to the unit time, is the final circulation route (the waiting track). One form is exemplified as the processor 180 selects one among the generated at least one or more circulation routes to set a waiting track. However, an exemplary form of the present disclosure is not limited thereto. For example, in one form, the user selects one of the at least one or more circulation routes as the waiting track.

In operation S130, the processor 180 performs autonomous driving of the vehicle along the set waiting track. At this time, after determining that the occupant in the vehicle gets off, the processor 180 performs the autonomous driving. The processor 180 may determine that the occupant gets down, through a sensor (e.g., a pressure sensor mounted on the seat) mounted in the vehicle. In addition, while performing the autonomous driving on the waiting track, the processor 180 measures a vehicle location through the location measurement device 120 to transmit the vehicle location to the user terminal 200 and the control server 300.

In operation S140, the processor 180 may determine whether a user call is received, while performing the autonomous driving. The user may call the vehicle to a pickup location through the user terminal 200. At this time, the user may designate the pickup location.

In operation S150, the processor 180 obtains a vehicle location in a waiting track and track information, when the user call is received. Herein, the track information may include a vehicle driving speed in a track, whether there is a vehicle entering a track, the number of vehicles in a track, and the like. The processor 180 may verify not only the vehicle location but also the user pickup location when there is a call from the user terminal 200.

In operation S160, the processor 180 calculates the movement time to the pickup location, based on the vehicle location in the waiting track. For example, the processor 180 adds a time period, during which the vehicle arrives from the current location to the exit location of the waiting track or the destination, to a time period during which the vehicle arrives from the exit location of the waiting track or the destination to the pickup location to calculate the movement time.

In operation S170, the processor 180 calculates an expected time to arrive at a pickup location, based on the calculated movement time to transmit the expected time to arrive at a pickup location. The processor 180 adds the calculated movement time to a current time to calculate the expected time to arrive at the pickup location.

In operation S180, the processor 180 moves the vehicle to the pickup location through the autonomous driving. In other words, the processor 180 controls the vehicle controller 160 to move the vehicle to the pickup location.

The present disclosure allows a vehicle to set a waiting track and to stand by while driving autonomously on the waiting track, while a driver treats his/her task, thereby saving time for entering a parking lot and parking time.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. An autonomous valet service method, the method comprising:
starting, by a processor, an autonomous valet service of a vehicle;
setting, by the processor, a waiting track for the autonomous valet service; and
performing, by the processor, autonomous driving of the vehicle in the waiting track.

2. The method of claim 1, wherein the setting the waiting track includes:
setting a unit time;
obtaining a current location of the vehicle;
generating at least one circulation route in each of which the current location of the vehicle is a start point or a destination; and
selecting one circulation route of the at least one circulation route based on the unit time.

3. The method of claim 1, wherein the setting the waiting track includes:
obtaining information of the waiting track from map data based on a current location of the vehicle.

4. The method of claim 1, wherein the setting the waiting track includes:
downloading information of the waiting track through scanning a Quick Response (QR) code or a barcode.

5. The method of claim 1, wherein, the performing the autonomous driving of the vehicle includes:
measuring a current location of the vehicle in real time, and transmitting the current location to a user terminal.

6. The method of claim 5, wherein, the performing the autonomous driving of the vehicle includes:
determining whether a call is received from the user terminal.

7. The method of claim 6, further comprising:
after the performing the autonomous driving of the vehicle, obtaining a vehicle location in the waiting track based on the call from the user terminal;
calculating a movement time from the vehicle location to a pickup location;
transmitting an expected time to arrive at the pickup location based on the calculated movement time; and
moving to the pickup location.

8. The method of claim 7, wherein the pickup location is implemented with a location designated by the user terminal.

9. The method of claim 7, wherein the pickup location is implemented with the current location of the user terminal.

10. The method of claim 7, wherein the pickup location is implemented with an exit location of the waiting track.

11. An autonomous valet service apparatus, comprising:
a user input device configured to activate an autonomous valet service;
a vehicle controller configured to control autonomous driving of a vehicle; and
a processor, wherein the processor is configured to:
start the autonomous valet service based on an input from the user input device;
set a waiting track for the autonomous valet service; and
control the vehicle controller and perform the autonomous driving of the vehicle in the waiting track.

12. The autonomous valet service apparatus of claim 11, further comprising:
a location measurement device configured to measure a vehicle location.

13. The autonomous valet service apparatus of claim 12, wherein the processor is configured to:
generate at least one circulation route, in each of which the vehicle location is a start point or a destination; and
select one circulation route of the at least one circulation route as the waiting track based on a preset unit time.

14. The autonomous valet service apparatus of claim 13, wherein the at least one circulation route comprises a plurality of circulation routes, and the processor is configured to determine a circulation route of the plurality of circulation routes as the waiting track when a time for the vehicle to move along the circulation route is approximately equal to the preset unit time.

15. The autonomous valet service apparatus of claim 12, further comprising:
a memory configured to store map data,
wherein the processor is configured to obtain information of the waiting track from the map data.

16. The autonomous valet service apparatus of claim 12, wherein the processor is configured to:
obtain information of the waiting track through scanning a Quick Response (QR) code or a barcode.

17. The autonomous valet service apparatus of claim 12, further comprising:
a communication device configured to perform wireless communication with a user terminal,
wherein the processor is configured to measure in real time a current location of the vehicle under the autonomous driving in the waiting track and transmit the current location to the user terminal.

18. The autonomous valet service apparatus of claim 17, wherein the processor is configured to:
calculate a movement time from the current location of the vehicle to a pickup location based on a call from the user terminal; and
transmit an expected time to arrive at the pickup location based on the calculated movement time, to the user terminal.
